(19) United States
(12) Patent Application Publication
(10) Pub. No.: US 2025/0114773 A1
(43) Pub. Date: Apr. 10, 2025

(54) Photocatalytic Degradation and Defluorination of Perfluoroalkyl Substances using Metal-Doped Boron Nitride Nanocomposites

(71) Applicant: William Marsh Rice University, Houston, TX (US)

(72) Inventors: Harikishan Kannan, Houston, TX (US); Jordin Metz, Houston, TX (US); Johanna Ikabu Bangala, Houston, TX (US); Ashok Kumar Meiyazhagan, Houston, TX (US); Sarah Glass, Houston, TX (US); Pulickel M. Ajayan, Houston, TX (US); Pedro Alvarez, Houston, TX (US)

(73) Assignee: William Marsh Rice University, Houston, TX (US)

(21) Appl. No.: 18/907,229

(22) Filed: Oct. 4, 2024

Related U.S. Application Data
(60) Provisional application No. 63/542,648, filed on Oct. 5, 2023.

(51) Int. Cl. B01J 27/24; B01J 23/745; B01J 35/39; B01J 37/04; B01J 37/06; C01B 21/064; C02F 1/32; C02F 1/72; C02F 101/36

(52) U.S. Cl. CPC B01J 27/24; B01J 23/745; B01J 35/39; B01J 37/04; B01J 37/06; C01B 21/0648; C02F 1/32; C02F 1/725; C01P 2002/54; C01P 2002/76; C01P 2002/85; C01P 2004/04; C02F 2101/36; C02F 2305/10

(57) ABSTRACT

Nanocomposites include boron nitride doped with a metal, where the boron nitride doped with a metal is catalytically active for degrading a perfluoroalkyl substance. Methods of making nanocomposites include forming a mixture by adding a salt comprising a metal cation to a powder comprising boron nitride; forming a dispersion by adding the mixture to a eutectic solvent; and reacting the metal with the boron nitride to form a product comprising the nanocomposite by heating the dispersion. Methods of treating a perfluoroalkyl substance include contacting the perfluoroalkyl substance with a nanocomposite comprising boron nitride doped with a metal; and degrading the perfluoroalkyl substance with the nanocomposite.

### CROSS REFERENCE TO RELATED APPLICATIONS

This application claims priority to U.S. Provisional Application Ser. No. 63/542,648, filed Oct. 5, 2023, entitled, “Photocatalytic degradation and defluorination of perflurooctanoic acid using iron-hexagonal boron nitride nanocomposites” which is hereby herein incorporated by reference.

### STATEMENT REGARDING FEDERALLY SPONSORED RESEARCH

This invention was made with government support under Grant No. 14495600 awarded by the National Science Foundation. The government has certain rights in the invention.

### BACKGROUND

PFAS, or perfluoroalkyl substances, are a group of more than 15,000 chemical compounds commonly known as “forever chemicals.” These fluorinated compounds have at least one CF₃ or CF₂ moiety in their structure and are very persistent due to their strong C—F bonds, which are not typically found in nature. They can be found in nonstick cookware coatings, pesticides, firefighting foam, water-resistant apparel, and industrial surfactants. PFAS have been historically manufactured and utilized despite their negative impact due to their useful physical properties, such as hydrophobicity, oleophobicity, and thermal stability. Unfortunately, these chemicals are pervasive and toxic to humans, in fact they have been detected in human blood. The entire class of PFAS includes polymers (e.g., Teflon) and non-polymers (e.g., perfluorooctanoic acid (PFOA)). The latter can be further broken down into perfluoroalkyl compounds (chains of carbon atoms only containing C—F bonds) and polyfluoroalkyl compounds (chains of carbon atoms, mainly-containing C—F bonds apart from some atoms such as oxygen and hydrogen).

Concern and effort to destroy the hazardous compound PFOA are widespread. For example, the US Environmental Protection Agency (EPA) proposed on Mar. 14, 2023, an extremely stringent Drinking Water Regulation standard of 4 parts per trillion (ppt) (also expressed as ng/L) for six PFAS including PFOA. In fact, this level is lower than those for fluoride, chloride, and even uranium, underscoring the seriousness of this issue. On Apr. 10, 2024, the EPA announced the final National Primary Drinking Water Regulation for these six PFAS. The limit, that is the maximum contamination level (MCL) is 4 ppt for perfluorooctanoic acid (PFOA), 4 ppt for perfluorooctane sulfonate (PFOS), 10 ppt for perfluorohexane sulfonic acid (PFHxS), 10 ppt for perfluorononanoic acid (PFNA), 10 ppt for hexafluoropropylene oxide dimer acid (HFPO-DA), and Hazard index value less than 1 (unitless) for mixtures containing two or more of PFHxS, PFNA, HFPO-DA, and perfluorobutanesulfonic acid (PFBS).

Stemming from strong carbon-fluorine bonds in PFOA, this hydrophobic and oleophobic water contaminant is highly pervasive and toxic, posing a serious threat to public and environmental health. PFOA is especially concerning because it is widely present and has been linked to health issues such as cancer, reproductive harm, and brain and kidney damage. Therefore, developing practical and economically feasible methods for destroying these hazardous chemicals is essential.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a nanocomposite including boron nitride doped with a metal, where the boron nitride doped with a metal is catalytically active for degrading a perfluoroalkyl substance.

In another aspect, embodiments disclosed herein relate to a method of making a nanocomposite, including forming a mixture by adding a cationic metal salt to boron nitride powder; forming a dispersion by adding the mixture to a eutectic solvent; and solvothermally reacting the metal with the boron nitride to form a product comprising the nanocomposite by heating the dispersion.

In yet another aspect, embodiments disclosed herein relate to a method of treating a perfluoroalkyl substance, including contacting the perfluoroalkyl substance with a nanocomposite comprising boron nitride doped with a metal; and degrading the perfluoroalkyl substance with the nanocomposite.

Other aspects and advantages of the claimed subject matter will be apparent from the following description and the appended claims.

### BRIEF DESCRIPTION OF THE DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings.

FIG. 1 shows graphs of defluorination percentage versus reaction time in for a nanocomposite accordance with one or more embodiments and for a comparative nanocomposite.

FIG. 2 illustrates degradation as shown in graphs of concentration versus reaction time for a nanocomposite accordance with one or more embodiments and for a comparative nanocomposite.

FIG. 3 shows a graph of concentration of byproducts versus time in accordance with one or more embodiments.

FIG. 4 shows a graph of concentration of byproducts versus time for a comparative photocatalyst.

FIG. 5 shows a schematic illustrating a reaction mechanism in accordance with one or more embodiments.

FIG. 6 shows a comparative schematic illustrating a comparative reaction mechanism for the comparative photocatalyst.

FIG. 7 shows degradation graphs in the presence or lack thereof of scavengers in accordance with one or more embodiments.

FIG. 8 illustrates a diminished role of a photogenerated hole for the comparative photocatalyst.

FIG. 9 shows schematic of a decarboxylation-hydroxylation-elimination-hydrolysis (DHEH) mechanism in accordance with one or more embodiments.

FIG. 10 shows a schematic illustrating favorable adsorption of a perfluoroalkyl substance on a nanocomposite in accordance with one or more embodiments.

FIG. 11 shows a comparative schematic illustrating unfavorable adsorption on a comparative nanocomposite.

FIG. 12 shows a schematic illustrating iso-surfaces of a perfluoroalkyl substance and charge transfer to a nanocomposite in accordance with one or more embodiments.

FIG. 13 shows a comparative schematic illustrating iso-surfaces of a perfluoroalkyl substance and charge transfer to a comparative nanocomposite.

FIGS. 14, 15, and 16 show graphs of deconvoluted XPS curve fitting for a photocatalyst in accordance with one or more embodiments.

FIG. 17 shows a TEM image in accordance with one or more embodiments.

FIG. 18 shows an image of HRTEM analysis in accordance with one or more embodiments.

FIG. 19 shows an image of a fast Fourier transform pattern in accordance with one or more embodiments.

FIG. 20 depicts equations used in a theoretical analysis in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

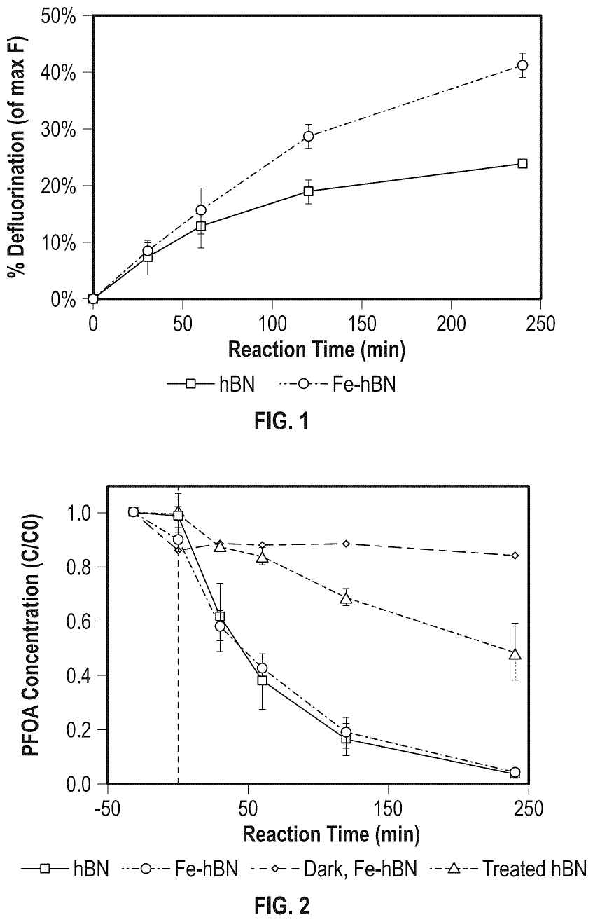

In the following description of FIGS. 1-20, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiply dependent claims are not introduced, it would be apparent to one of ordinary skill that the subject matter of the dependent claims of one or more embodiments may be combined with other dependent claims.

Here, a straightforward and scalable process to heterogeneously functionalize and dope hexagonal boron nitride (hBN) with Iron (Fe) has been specifically developed to enhance photocatalytic degradation and extensive defluorination of PFOA using eco-friendly deep-eutectic solvents (DES). The synthesized Fe-hBN nanocomposite displayed double the defluorination (˜50% fluoride release from initial 34 mg L⁻¹ of fluoride species) compared to undoped hBN within 4 hours under 254 nm UVC irradiation. This material demonstrates a novel pathway to simultaneously destroy the parent PFOA chain and the shorter carbon-fluorine daughter products, specifically within a shorter duration, through a photooxidative reaction pathway. Of the several solutions proposed for PFOA degradation thus far, the rapid defluorination observed, the facile solvothermal approach, the novelty in the chemistry, and the scalability of producing these nanocomposites make it a far superior approach. Furthermore, this technology is universally applicable in several other areas, including catalysis, sensors, optoelectronic and spintronic devices, thus showcasing their potential for commercialization.

Breaking down PFOA through photocatalytic methods involves various mechanisms, mainly advanced oxidation, and reduction processes. These mechanisms provide an active site for direct oxidation or reduction and create radical species like ·OH and O₂^{·-} that participate in further degradation of the parent molecule. Different materials have been proposed to facilitate PFOA degradation, including Fe(III), TiO₂, In₂O₃, β-Ga₂O₃, SiC, and hBN. Despite these materials having a wide bandgap, it is the mid-gap states formed resulting from crystal structure defects that have enabled them to be useful for photocatalytic purposes. For instance, boron nitride (BN) can absorb 254 nm light (UVC) to generate a hydrophobic reactive electron hole for the initial attack on PFOA, then it can generate reactive oxygen species (ROS) to further the reaction.

In general, hBN is a unique material with excellent properties and applications in diverse fields. It includes its use as an industrial lubricant, dielectric material in semiconductor devices, quantum sensors, and photocatalysis. However, the applicability of hBN is commonly met with one central challenge—strong chemical inertness arising from robust and polar B—N bonds and an ultra-wide bandgap. Therefore, the necessity to overcome this challenge through chemical functionalization and heterogeneous doping offers a strong value proposition and added impetus for its use in all applications. Here, an entirely innovative process adopting a facile green-chemistry route to modify hBN by covalently anchoring Iron (Fe) to the hBN surface has been specifically developed to synthesize a novel photocatalyst: Fe-hBN nanocomposites.

It will be understood that the above-described Fe-doped hBN is illustrative of metal-doped boron nitride. Similarly, it will be understood that the above-described PFOA is illustrative of PFAS.

In one aspect, embodiments disclosed herein relate to a nanocomposite including boron nitride doped with a metal. The metal may be one or more transition metals. As is known to one of skill in the art, transition metals include metals of Groups 3-12 of the IUPAC Periodic Table of the Elements (latest release May 4, 2022). For example, the metal may be one or more transition metal from among titanium, iron, ruthenium, osmium, cobalt, rhodium, iridium, nickel, palladium, platinum, copper, silver, gold, and alloys thereof. For example the transition metal may include or be iron. The boron nitride may include or be hexagonal boron nitride. An advantage of hexagonal boron nitride is that it is the most stable polymorph. Alternatively or in combination, another form of boron nitride contemplated is cubic boron nitride (cBN).

The nanocomposite may be catalytically active for degrading a perfluoroalkyl substance. The perfluoroalkyl substance may be selected from among polymers, non-polymers and combinations thereof. The polymers may be selected from among fluoropolymers, a perfluorpolyethers (PEPE), and side-chain fluorinated polymers, and combinations thereof. The non-polymers may be selected from among perfluoroalkyl acids (PFAA), a perfluoroalkyl carboxylic acids, a perfluoroalkyl sulfonic acids, a perfluoroalkyl sulfonamides (FASA), perfluoroalkyl iodides (PFAI), perfluoralkyl aldehydes, and combinations thereof. Thus, for example, the nanocomposite may be catalytically active for degrading one or more of perfluorooctanoic acid (PFOA), perfluorooctane sulfonate (PFOS), perfluorohexane sulfonic acid (PFHxS), perfluorononanoic acid (PFNA), hexafluoropropylene oxide dimer acid (HFPO-DA), and perfluorobutanesulfonic acid (PFBS). Thus, for example, the perfluoroalkyl substance may be perfluorooctanoic acid. The catalytic activity may include a defluorination rate of at least about 40% F⁻ species, for example about 50% of F⁻ species. The catalytic activity may be more than the catalytic activity of a corresponding boron nitride that is not doped with the metal. The catalytic activity may at least twice the catalytic activity of a corresponding boron nitride that is not doped with the metal. It will be understood that as used herein the term “perfluoroalkyl substances” is interchangeable with “per- and polyfluoroalkyl substances.”

In another aspect, embodiments disclosed herein relate to a method of making a nanocomposite, including forming a mixture by adding a cationic metal salt to boron nitride powder. The boron nitride powder may include particles ranging in size from 10 nanometers (nm) to 100 microns (μm). The metal may be a transition metal. For example, the metal may be one or more transition metal from among titanium, iron, ruthenium, osmium, cobalt, rhodium, iridium, nickel, palladium, platinum, copper, silver, gold, and alloys thereof. For example, the transition metal may include or be iron. The boron nitride powder may include one or more of hexagonal boron nitride powder and cubic boron nitride powder. For example, the boron nitride powder may include or be hexagonal boron nitride powder.

The method may further include forming a dispersion by adding the mixture to a eutectic solvent. The eutectic solvent may include a combination of ethylene glycol and choline chloride. For example, the eutectic solvent may include ethylene glycol and choline chloride in a molar ratio of 2:1.

The eutectic solvent may be a deep eutectic solvent. A list of suitable deep eutectic solvents and exemplary molar ratios for the components of the deep eutectic solvents is provided in Table 1.

TABLE 1

| Deep Eutectic Solvent | Molar Ratio |
|---|---|
| Urea:ChCl (reline) | 2:1 |
| Ethylene glycol:ChCl (ethalene) | 2:1 |
| Glycerol:ChCl (glyceline) | 2:1 |
| Thiourea:ChCl | 2:1 |
| Malonic acid:ChCl | 1:2 |
| Oxalic acid:ChCl | 1:1 |
| Imidazole:ChCl | 3:7 |
| Benzamide:ChCl | 1:2 |
| Citric acid:ChCl | 1:2 |
| Adipic acid:ChCl | 1:1 |
| Benzoic acid:ChCl | 1:1 |
| ZnCl₂:ChCl | 1:2 |
| Phenylpropionic acid:ChCl | 1:1 |
| Phenyllactic acid:ChCl | 1:1 |
| Acetamide:ChCl | 1:2 |
| Glucose:ChCl | 1:1 |
| Tricarballylic acid:ChCl | 1:1 |
| Levulinic acid:ChCl | 1:2 |
| Succinnic acid:ChCl | 1:1 |
| EtNH₃Cl:TFA | 1:1.5 |
| EtNH₃Cl:Urea | 1:1.5 |
| Betaine hydrochloride:Ethylene glycol | 1:5 |

In Table 1, “ChCl” indicates choline chloride, “TFA” indicates trifluoroacetic acid, and “Et” indicates ethyl.

The eutectic solvent may be eco-friendly. It will be understood the eco-friendly may refer to the property of not being harmful to the environment. For example, the eutectic solvent may contain components that are not identified by the EPA as a hazardous waste, for example that do not have an EPA hazardous waste code. For example, the eutectic solvent may exclude each of benzene, toluene, carbon tetrachloride, chloroform, hexachlorobenzene, hexachlorobutadiene, hexachloroethane, methyl ethyl ketone, and tetrachloroethylene.

The method may further include adding a secondary solvent to the eutectic solvent to form a resultant solvent. The resultant solvent may be a mixture of the eutectic solvent and the secondary solvent. The secondary solvent may be added to the eutectic solvent before adding the mixture of metal salt and boron nitride powder to the eutectic solvent, resulting in the method including adding the mixture of metal salt and boron nitride powder to the resultant solvent. The secondary solvent may be dimethylformamide. The secondary solvent may be used to adjust the properties of the resultant solvent. The properties may include one or more of viscosity, polarity, boiling point, density, vapor pressure, miscibility, and surface tension. It is within the skill of one of ordinary skill in the art to select a secondary solvent for a given eutectic solvent, such as the eutectic solvents given in Table 1.

The method may further include solvothermally reacting the metal with the boron nitride to form a product comprising the nanocomposite by heating the dispersion. The nanocomposite may be a nanocomposite as described above. Thus, for example, the nanocomposite may include boron nitride doped with a metal. The metal may be the metal as describe above for the salt including a cation of a metal. The metal may be a transition metal. For example, the metal may be one or more transition metal from among titanium, iron, ruthenium, osmium, cobalt, rhodium, iridium, nickel, palladium, platinum, copper, silver, gold, and alloys thereof. For example, the transition metal may include or be iron. The boron nitride may be the boron nitride as described above for the a powder including boron nitride. The boron nitride may include one or more of hexagonal boron nitride, and cubic boron nitride. The nanocomposite may be catalytically active for degrading a perfluoroalkyl substance.

The method may include forming a nanocomposite that is catalytically active for degrading a perfluoroalkyl substance. As described above, the perfluoroalkyl substance may be selected from among polymers, non-polymers and combinations thereof. The polymers may be selected from among fluoropolymers, a perfluorpolyethers (PEPE), and side-chain fluorinated polymers, and combinations thereof. The non-polymers may be selected from among perfluoroalkyl acids (PFAA), a perfluoroalkyl carboxylic acids, a perfluoroalkyl sulfonic acids, a perfluoroalkyl sulfonamides (FASA), perfluoroalkyl iodides (PFAI), perfluoralkyl aldehydes, and combinations thereof. Thus, for example, the nanocomposite may be catalytically active for degrading one or more of perfluorooctanoic acid (PFOA), perfluorooctane sulfonate (PFOS), perfluorohexane sulfonic acid (PFHxS), perfluorononanoic acid (PFNA), hexafluoropropylene oxide dimer acid (HFPO-DA), and perfluorobutanesulfonic acid (PFBS). Thus, for example, the perfluoroalkyl substance may be perfluorooctanoic acid.

The catalytic activity may be more than the catalytic activity of a corresponding boron nitride that is not doped with the metal. The catalytic activity may include a defluorination rate of at least about 40% F⁻ species, for example about 50% of F⁻ species. The catalytic activity may be at least twice the catalytic activity of a corresponding boron nitride that is not doped with the metal. The method may further include forming a phase-separated mixture by washing the product with a mixture of a polar solvent and nonpolar solvent. Washing the product may include mixing the product with the mixture of a polar solvent and nonpolar solvent and centrifuging the product in the mixture of the polar solvent and the nonpolar solvent. Alternatively, or in combination, any suitable separation method between solids and liquids other than centrifuging may be used.

The method may further include removing unreacted and/or organic byproducts from the phase-separated mixture. The unreacted and organic byproducts may be in solution in the mixture of the polar solvent and nonpolar solvent. The mixture may itself separate into a polar phase and non-polar phase on standing. The mixture may be largely a dispersion, suspension or other finely combined mixture of the polar and nonpolar solvent upon centrifuging. Removing the unreacted and/or organic byproducts from the phase-separated mixture may be performed by decanting the unreacted and/or organic byproducts from the phase-separated mixture. They may be removed while in solution in the mixture of the polar solvent and nonpolar solvent.

In another aspect, embodiments disclosed herein relate to a method of treating a perfluoroalkyl substance including contacting the perfluoroalkyl substance with a nanocomposite comprising boron nitride doped with a metal. The method may further include degrading the perfluoroalkyl substance with the nanocomposite. The catalytic activity may include a defluorination rate of at least about 40% F⁻ species, for example about 50% of F⁻ species. The catalytic activity may be more than the catalytic activity of a corresponding boron nitride that is not doped with the metal. For example, the catalytic activity may be at least twice the catalytic activity of a corresponding boron nitride that is not doped with the metal. Thus, the method may further include enhancing the activity of the nanocomposite for the degrading of the perfluoroalkyl substance in comparison to a corresponding boron nitride that is not doped with the metal. For example, the method may further include enhancing the activity of the nanocomposite for the degrading of the perfluoroalkyl substance in comparison to a corresponding boron nitride that is not doped with the metal by a factor of at least two.

The nanocomposite may be a nanocomposite as described above. Thus, the metal may be a transition metal. For example, the metal may be one or more transition metal from among titanium, iron, ruthenium, osmium, cobalt, rhodium, iridium, nickel, palladium, platinum, copper, silver, gold, and alloys thereof. For example, the transition metal may include or be iron. The boron nitride may be the boron nitride as described above for the a powder including boron nitride. The boron nitride may include one or more of hexagonal boron nitride and cubic boron nitride.

The method may include treating one or more perfluoroalkyl substances. Thus, the perfluoroalkyl substance may be selected from among polymers, non-polymers and combinations thereof. The polymers may be selected from among fluoropolymers, a perfluorpolyethers (PEPE), and side-chain fluorinated polymers, and combinations thereof. The non-polymers may be selected from among perfluoroalkyl acids (PFAA), a perfluoroalkyl carboxylic acids, a perfluoroalkyl sulfonic acids, a perfluoroalkyl sulfonamides (FASA), perfluoroalkyl iodides (PFAI), perfluoralkyl aldehydes, and combinations thereof. Thus, for example, the nanocomposite may be catalytically active for degrading one or more of perfluorooctanoic acid (PFOA), perfluorooctane sulfonate (PFOS), perfluorohexane sulfonic acid (PFHxS), perfluorononanoic acid (PFNA), hexafluoropropylene oxide dimer acid (HFPO-DA), and perfluorobutanesulfonic acid (PFBS). Thus, for example, the perfluoroalkyl substance may be perfluorooctanoic acid.

The present nanocomposite, method of making the nanocomposite, and method of treating a perfluoroalkyl substance using the nanocomposite have the advantages of providing material and methods that provide superior performance for degrading perfluoralkyl substances, and thus removing perfluoralkyl substances from drinking water.

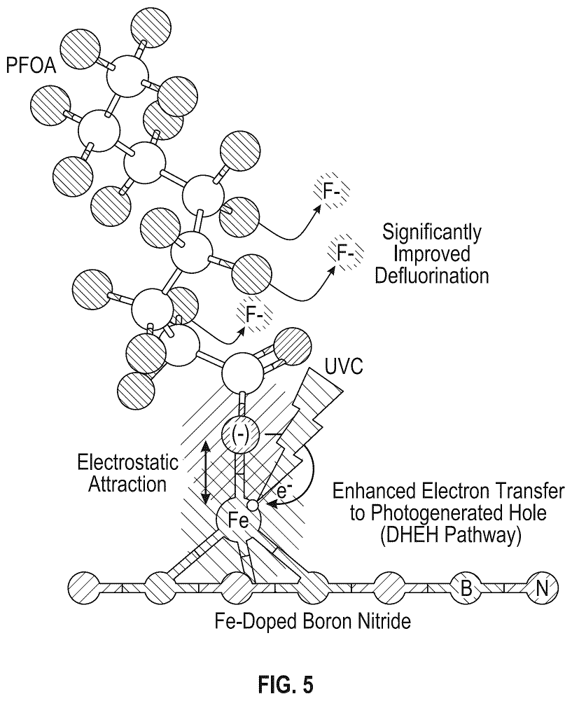

Results of testing for defluorination of perfluorooctanoic acid by iron-doped boron nitride described further below, for example with reference to FIGS. 1-4, illustrate the superior activity of the present metal-doped boron nitride. For example, with reference to FIG. 1, the testing for defluorination of perfluorooctanoic acid by iron-doped boron nitride demonstrates catalytic activity of the present nanocomposite may be at least twice the catalytic activity of a corresponding undoped boron nitride. Based on the testing when the metal was iron and the perfluoroalkyl substance was perfluorooctanoic acid, and a believed mechanism of action described herein in the examples, for example as illustrated by FIG. 5, the present inventors expect similar improvement of catalytic activity of the metal-doped boron nitride when the metal is another suitable metal as described herein, and when the perfluoroalkyl substance is another suitable perfluoroalkyl substance as described herein.

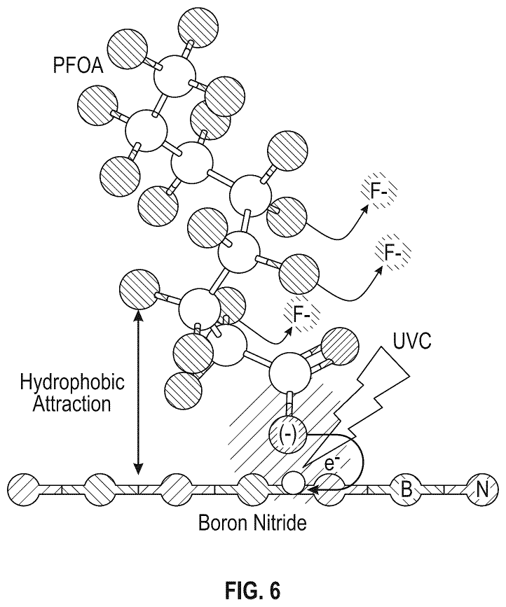

The improved defluorination performance observed in the examples described below when the metal was iron was unexpected. Iron was not expected to have catalytic activity because the defluorination is an oxidation process, iron generates OH radicals, and OH radicals cannot oxidize perfluorooctanoic acid. While not wishing to be limited by theory, the present inventors believe that, as illustrated in FIG. 5, the iron promotes the catalytic activity of the iron-doped boron nitride through a mechanism of action involving iron enhancing electron transfer to photogenerated holes in the iron-doped boron nitride, where the enhancement is in comparison to undoped boron nitride, as illustrated in FIG. 6, where the catalytic activity for the defluorination activity involves electron transfer to photogenerated holes. The present inventors note that, as shown in FIG. 5, the mechanism involves electrostatic interaction between an oxygen of the perfluoroalkyl substance and the metal. This electrostatic interaction is absent from the comparative boron nitride, as illustrated in FIG. 6.

The following examples are intended to illustrate the invention and are not intended to limit the invention to the following. The present invention can be carried out with appropriate modifications within the scope of the gist of the invention.

### Examples

Referring to FIGS. 1-20, the examples illustrate the present nanocomposite including a boron nitride doped with a metal, the present method of making the nanocomposite, and the present method of treating a perfluoroalkyl substance (PFAS) with the nanocomposite where iron is exemplary of the metal, hexagonal boron nitride is exemplary of the boron nitride, and perfluorooctanoic acid is exemplary of the perfluoroalkyl substance. These examples are based in part on a preprint manuscript entitled “Photocatalytic defluorination of perfluorooctanoic acid using Fe-doped h-BN: the enhancing role of the transition metal,” by S. Glass, et al.

Extensive PFAS pollution poses a formidable threat to public health due to their severe toxicity and extreme persistence. Eliminating this liability requires extensive PFAS defluorination during water treatment, which is an unmet challenge for catalytic advanced oxidation processes. Overcoming this challenge requires a more complete understanding of the factors limiting oxidative defluorination of these “forever chemicals”. Here, hBN (a common semiconductor and a known photocatalyst that degrades PFOA) was doped with Fe(III) to show that such transition metals can enable electrostatic adsorption and subsequently enhance direct electron transfer from PFOA to the catalyst active sites to improve defluorination extent, as illustrated for example by FIGS. 1-4. This mechanistic insight, as illustrated for example by FIGS. 5-6, informs catalytic materials design to promote complete PFAS defluorination resulting in mineralization and toxicity elimination.

### General Procedures

All the chemicals used in this study were of analytical grade. hBN powder (1 μm particle size, 98% purity), Perfluorooctanoic acid (C₈F₁₅O₂H, 96% purity), and Iron (II) chloride tetrahydrate (FeCl_{2X}4·H₂O, 98% purity) were obtained from Sigma Aldrich and used as received. Dimethylformamide (DMF) and DES (comprised of Ethylene glycol and Choline chloride (2:1 molar ratio)) served as the reaction precursors for the catalyst synthesis. 39.76 mg of FeCl_{2X}4·H₂O was added to 496 mg of hBN representing 1% by mole metal loading. To the dry mix, a solution of 3 mL DMF and 5 mL DES was added, manually shaking to ensure uniform dispersion before placing it into the reactor. The solvothermal reaction was carried out at 180° C. for 18 hours, then cooled to room temperature before opening the reactor. The samples were then washed by mixing the final reactant mixture with a non-polar and polar solvent combination (1:1 hexane-ethanol) and centrifuging at 12,000 rpm for 40 minutes. The unreacted and organic byproducts were decanted from the phase-separated mixture, and the same washing procedure was repeated at least twice. The final sample residue was collected and oven-dried overnight to obtain the catalyst sample used in this study.

All photocatalytic experiments were conducted using an initial 20 mL solution containing 50 mg L⁻¹ (120.75 μM) of PFOA and 1.0 g L⁻¹ of the photocatalyst. The reaction vessel was a 100 mL quartz round bottom flask with a PTFE-coated magnetic stir bar, sealed with a septum. The initial pH measured before adding the photocatalyst was 3.8 to 4.0. To attain an optimum pH of 3.2, about 10 μL of 1M HCl was added to the reaction solution. At −30 minutes (30 minutes before irradiation), a 1 mL sample was taken using a 5 mL syringe and filtered with a 0.22 μm PES syringe filter before massing the required photocatalyst to attain 1.0 g L⁻¹ concentration. The hBN concentration was 1.0 g L⁻¹ for economic and calculations convenience, selected from within an expected suitable range of 0.5 to 2.5 gL. After 30 minutes of mixing in the dark, the 0-minute sample was taken as described above. The photocatalytic reactor was furnished with a stir plate and six 4 W UVC Ushio G4T5 low-pressure mercury germicidal lamps. Aliquots for sampling were taken at set intervals (−30, 0, 30, 60, 120, and 240 minutes) during the reaction. Whereas sampling increased the headspace to liquid volume ratio, this resulted in minor effects on dissolved PFOA concentrations as observed in dark controls (not shown), due to the non-volatile nature of PFOA (i.e., vapor pressure=2.17×10⁻⁵ atm at 20° C. and Henry's law constant=2.4×10⁻⁵ atm-m³/mol). Inductively coupled plasma optical emission spectroscopy (ICP-OES) was conducted on postreaction mixtures to quantify possible Fe leaching before and after the photocatalytic experiment, which was not detected. All experiments were repeated for two Fe-hBN synthesized batches and conducted in triplicate.

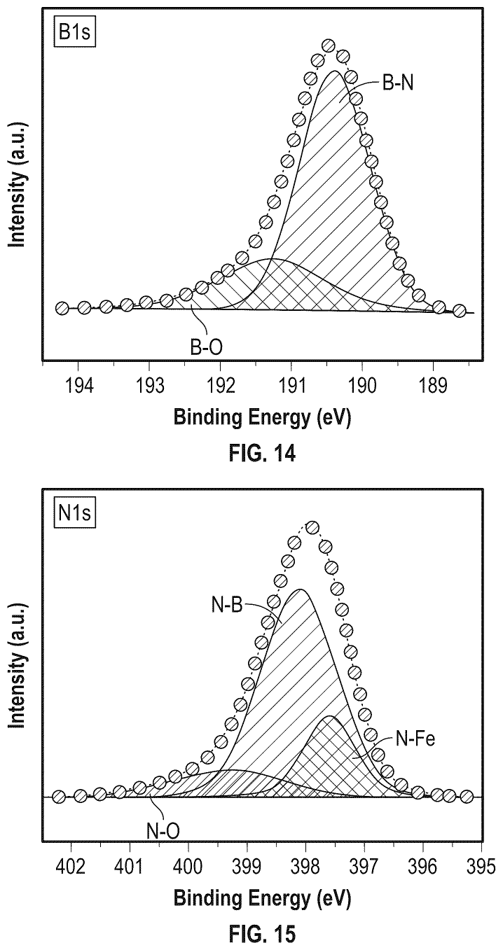

The Vienna ab initio Simulation Package (VASP 5.4.4) was applied to perform the density functional theory (DFT) calculations. Perdew-Burke-Ernzerhof (PBE) exchange-correlation functional within the projector augmented wave (PAW) formalism was used. The valence electrons of C (2s²2p²), O (2s²2p⁴), F (2s2²p⁵) Fe (2s²2p⁶3d⁶4s²), and H (1s¹) were treated self-consistently. All the calculations were spin-polarized. The kinetic energy cutoff was set at 550 eV and a Monkhorst-Pack k-point mesh of 3×3×1 was used for sampling the Brillouin zone on a 6×6 monolayer hBN surface model. Gaussian smearing was employed with a smearing width of 0.05 eV. van der Waals interactions were described by Grimme's DFT-D3 dispersion. All self-consistent-field electronic optimizations were converged to within 0.01 meV and all geometry optimizations were converged to forces within 0.02 eV Å⁻¹. The charge neutrality of the periodic unit cell is enforced by applying the VASPsol implicit solvation model, which places implicit counterions in the electrolyte to screen net charge and net dipole. An implicit electrolyte region of 35 Å was employed perpendicular to the hBN surface. The effective surface tension (τ) parameter was set to zero to avoid instabilities in the local electrostatic potential in the electrolyte region. For the Fe(III)-doped hBN surface model, we placed one Fe atom in a 6×6 hBN unit cell substituting a B atom, which yields a formal 3+ charge state on the Fe atom and corresponds to the identified Fe—N bonds characterized by the XPS experiment in FIG. 14.

Since the focus was on understanding the effect of doping Fe(III) on charge transfer, a model (smaller) C3 PFCA− anion (CF3CF2COO—) was considered for computational efficiency. It was known from previous work of the present inventors that the charge transfer characteristics (i.e., oxidation potential) of PFCA anions are not sensitive to the chain length. Thus, this model C3 PFCA is representative of the oxidation potential of PFOA for assessing the effect of iron doping on charge transfer. The anionic, deprotonated form of the PFCA molecule was employed due to a higher pH in the PFOA degradation experiments than the pKₐ of PFOA (˜0).

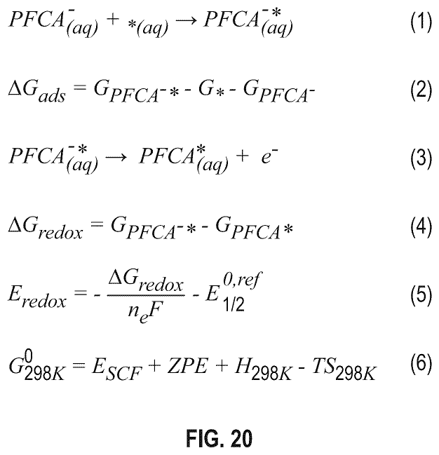

The reaction free energy (ΔG_{ads}) for adsorption of the PFCA⁻ anion on pristine hBN or Fe-doped hBN shown in Eqn. 1 (FIG. 20) is calculated using Eqn. 2 (FIG. 20). where PFCA− represents the −1e charged 3C PFCA− anion (CF3CF2COO—), * represents 6×6 pristine or Fe-hBN surface at a charge state of 0 e, and PFCA−* is the adsorbed configuration with a net charge of −1 e. The subscript _{(aq)} in Eqn. 1 and in the equations below indicates that implicit solvation is applied in the simulation.

The oxidation potential (E_{redox}) of PFCA− anion after adsorption on the pristine-hBN or Fe-hBN surface is calculated by Eqns. 3-5 (FIG. 20), where PFCA* represents the adsorbed PFCA on Fe-hBN or pristine hBN system with a net charge of 0 e, F represents Faraday's constant, ne is the number of electrons in the reaction equation, ΔG_{redox} represents the reaction free energy, and E^{0,ref}_{1/2} is the reference potential, which is the standard hydrogen electrode (SHE) in our calculation. The empirical absolute value for SHE that was used was 4.44 V. The absolute Gibbs free energy of the species is calculated using Eqn. 6 according to standard formulae derived from statistical mechanics (FIG. 20), where E_{SCF} represents the ground state electronic energy at 0 K, ZPE represents the zero-point energy, T represents the temperature (298 K), H₂₉₈K is the enthalpy correction at 298 K, and S_{298K} represents the entropy energy at 298 K. We use the ZPE+H_{298K}−TS_{298K} correction values computed for the equivalent molecule geometry using the NorthWest Chemistry (NWChem) modeling software. For the free energy change from free PFCA⁻ anion to the adsorbed configuration, we considered only the entropy change related loss of translational and rotational degrees of freedom. Two-dimensional translational and rotational degrees of freedom were retained for PFCA species physiosorbed on the pristine hBN surface, while the translational an rotational degrees of freedom are considered to be totally lost for the chemisorbed PFCA on Fe site of Fe-hBN surface. This assumption represents an upper bound (i.e., least favorable) for the computed PFCA binding energy on the Fe-hBN site. The free energies are calculated at a PFCA concentration of 50 mg L⁻¹ (120.75 μM). No free energy correction is applied on the catalyst surface itself, as it is assumed that these corrections will effectively cancel in Eqns. 2 and 4 (FIG. 20).

Bader charge analysis was performed to determine the qualitative nature of charge transfer between the PFCA anion and an electron-hole located on hBN. Given the computational expense of excited-state methods, the entire photo-driven charge transfer mechanism occurring on an extended catalyst surface was not studied. Thus, several assumptions were made when drawing conclusions from ground-state DFT. In the photo-catalytic system studied herein, it was assumed that it is the Fe—BN catalyst that undergoes direct excitation by incident light, rather than excitation of the PFOA molecule. Excitation of hBN forms a bound-exciton, which we was assumed to undergo rapid charge separation given the localization of mid-gap states on the Fe cation and the delocalization of conduction band states across the hBN surface. It was known from previous work of the present inventors that the reduction potential of O₂ is well below the conduction band of hBN, indicating that excited conduction band electrons will be rapidly consumed by O₂. Thus, the PFOA was assumed to be oxidized by electron transfer to an electron-hole localized on an Fe site, which we can model qualitatively with ground-state DFT.

The examples describe an exemplary approach to heterogeneously functionalize and dope hexagonal boron nitride (hBN) with Iron (Fe) involves solvothermal conditions is described, using a combination of Deep-Eutectic-Solvents (DES) comprising varied molar ratios of Ethylene Glycol (EG) and Choline Chloride (CC) along with Dimethylformamide (DMF) as an active liquid medium to simultaneously enable covalent functionalization and doping of the iron atom onto hBN to produce a Fe-hBN nanocomposite. The examples further describe degrading and defluorinating PFOA with the produced Fe-hBN nanocomposite.

An overall experimental procedure was carried out as follows. In brief, the synthesis methodology developed involves a three-step process comprising but not limited to solvothermal heating and solvent washing, followed by overnight drying, paving the way for synthesizing Fe-hBN nanocomposite. This methodology entails the synthesis of highly defect-rich hBN that acts as an excellent precursor for the incoming Iron (II) chloride salt to react with. This novel approach is simple to carry out in design and uses water-soluble green solvents like ethylene glycol and choline chloride, commonly known as DES mixtures. Although this process was developed specifically for a photocatalytic application, it is equally important to note that such a methodology chalks out a new pathway for the customized design of several new modified hBN nanocomposites highly relevant for a significantly wider gamut of applications.

A material synthesis for the preparation of Fe-hBN nanocomposites was carried out. A step-wise process design of developing Fe-hBN nanocomposites involved sample preparation, followed by sequential solvothermal heating, sample washing, and overnight drying.

The sample was prepared in an autoclave setup. The sample preparation involved combining hexagonal boron nitride and a metal precursor that was iron (II) chloride salt in an amount of 1% by mole dosage with respect to the hexagonal boron nitride in the presence of a solvent including a deep eutectic solvent (DES). The solvent further included dimethyl formamide (DMF). The DES was a combination of ethylene glycol and choline chloride. The combination of ethylene glycol and choline chloride was believed to have a structure of chlorine anion associated to the positively charged nitrogen of the choline cation and to hydroxyl of the ethylene glycol, with the chlorine anion disposed between the choline cation and the ethylene glycol.

Suitable conditions for the solvothermal heating were found to be a temperature of from 100° C. to 200° C. and a duration of from 12 to 24 hours. The product after solvothermal heating was sample washed. The sample washing included washing the product with a mixture of a polar solvent and nonpolar solvent to produce a phase-separated mixture. The polar solvent was ethanol and the non-polar solvent was hexane. The phase-separated mixture was centrifuged and the unreacted and organic byproducts were removed from the phase-separated mixture to leave the final product of Fe-hBN nanocomposite, which was then dried overnight.

The process entailed the synthesis of highly stable Fe-hBN nanocomposites of high yield and a color change upon visual inspection. The high yield was observed to be greater than 85% and the color change was observed to be from white after sample preparation to brown after sequential solvothermal heating, sample washing, and overnight drying.

The sample washing removes alkyl chloride functionalities and unreacted precursors. The sample washing is exemplary of sample purification. The present inventors contemplate alternative processes for purification. For example, a membrane-based filtration system may be used that can selectively and quickly remove impurities.

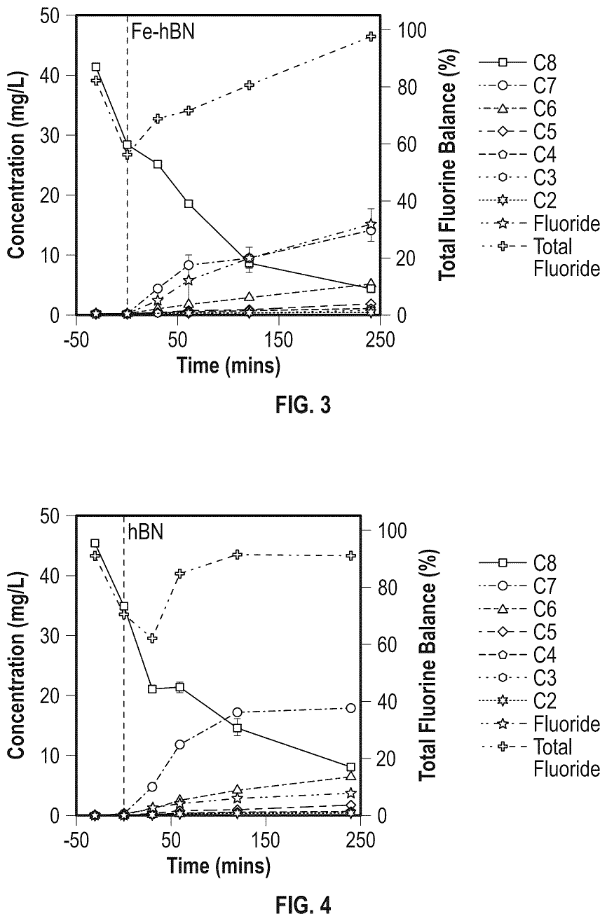

The photocatalytic measurements were carried out using synthesized nanocomposites subjected to interacting with a starting concentration of 50 ppm PFOA at 1.0 g L⁻¹ catalyst loading. The pH was normalized to 3.2, and the aliquots for sampling were taken at set 30-minute intervals. The photocatalytic measurement process is shown in FIG. 3. The degradation and defluorination rates of PFOA were quantified using high-performance liquid chromatography (HPLC) and ion chromatography (IC) equipment, respectively.

A step-wise process of photocatalysis to quantify PFOA degradation and defluorination was carried out. 19 milliliter (mL) DI water and 1 mL of PFOA were mixed. The pH of the mixture was measured to be 3.97. The pH was normalized to 3.2. To 1 mL of the resulting mixture, 19 mg of hexagonal boron nitride doped with iron was added to form a reaction mixture. Aliquots of sample of the reaction mixture were taken at 30, 60, 120, and 240 min. The extent of degradation and defluorination of PFOA in the aliquots of sample was measured. Results are shown in FIG. 1.

As shown in FIG. 2, the photocatalytic measurements showed a rapid decrease in the concentrations of PFOA using hBN and Fe-hBN, with the latter exhibiting a slightly higher degree of degradation in PFOA levels. No degradation was observed in the dark, confirming light's necessity for degradation. The Fe-hBN samples did show a slight decrease in PFOA levels in the dark due to the adsorption of the recalcitrant on the hBN surface and not due to the cleavage of C—F bonds. The control DES-hBN with no metal exhibited inferior degradation rates compared to hBN, attributed to higher electron-hole recombination rates due to poor electron transport arising from randomly oriented alkyl groups on the hBN surface.

The present Fe-hBN nanocomposite reactions yielded a PFOA half-life of 0.75 h with a photocatalytic removal rate of 0.174 mg of PFOA L⁻¹ m⁻¹, comparable to the hBN system's PFOA half-life of 1 h and 0.166 mg of PFOA L⁻¹m⁻¹ removal rate. After 240 minutes, PFOA concentrations remained undetectable in both Fe-hBN and hBN systems. The defluorination metric indicates the amount of fluoride species released directly from the degraded PFOA chain. The Fe-hBN samples showed double the defluorination concentrations compared to hBN. After 240 minutes, ˜50% of the total initial fluorine—34 mg L⁻¹ was released as F− for Fe-hBN at 1.0 g L⁻¹ dosage compared to ˜20% of F⁻ release for hBN. This higher rate of excess F⁻ species release is due to shorter chains undergoing degradation. It represents the highest defluorination rate reported using hBN or modified hBN nanocomposites for photocatalytic degradation of PFOA to date.

FIG. 1 demonstrates that Fe-hBN photocatalyst shows twice the degree of defluorination compared to hBN, the highest reported values of all PFOA works using hBN and modified hBN nanocomposites. More specifically, FIG. 1 demonstrates that fluoride release shows doubled defluorination extent for Fe-hBN (>40%) compared to hBN.

FIG. 2 demonstrates degradation of PFOA measured in the dark and under UVC light demonstrates photocatalyst Fe-hBN showing a slightly higher degradation rate than hBN. More specifically, FIG. 2 shows PFOA (C₀=50 mg/L) removal patterns were similar with hBN and Fe-hBN after 254-nm irradiation (64.4 W/m²).

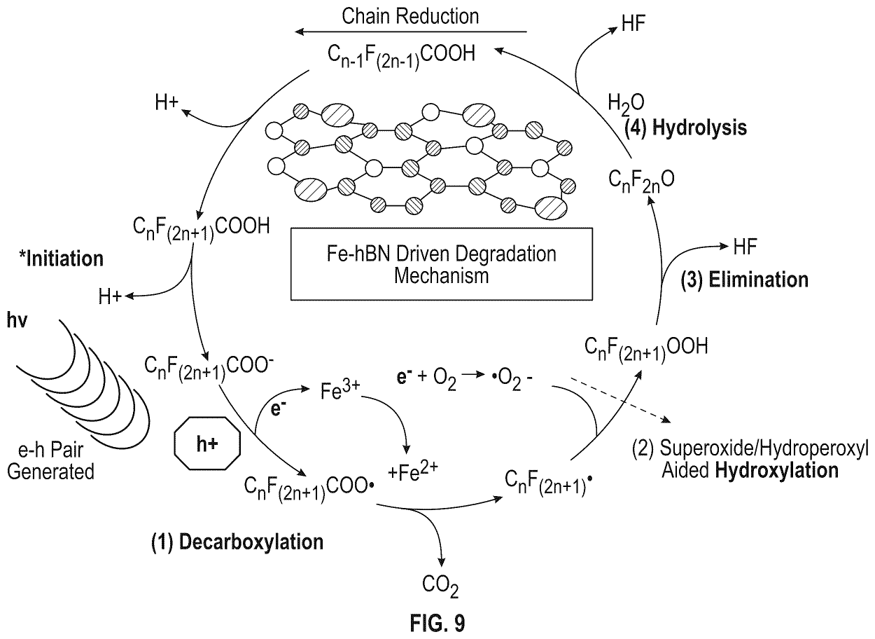

A comparison of FIG. 3 with FIG. 4 shows less accumulation of byproducts with Fe-hBN corroborates enhanced defluorination. Further, a comparison of FIG. 3 with FIG. 4 shows supports a decarboxylation-hydroxylation-elimination-hydrolysis (DHEH) mechanism degradation mechanism. The DHEH mechanism is illustrated in FIG. 9.

FIGS. 1-4 illustrate that Fe-doping enhanced PFOA degradation. Fe doping of hBN not only restored the PFOA removal efficiency of hBN (which was deteriorated by the solvothermal process), but also doubled the defluorination extent. After 240 minutes, ˜40% of the total initial fluorine (34.4 mg L⁻¹) was released as F⁻ with 1.0 g L⁻¹ dosage of Fe—BN, compared to ˜20% for undoped hBN at the same catalyst dosage (FIG. 1). Normalizing fluoride release activity to the Fe-hBN concentration indicates a defluorination rate of 3.6 mg F⁻ released g-catalyst⁻¹ hour⁻¹, which is nearly twice that with undoped hBN (2.0 mg F⁻ released g-catalyst⁻¹ hour⁻¹), and it is also double the rate previously observed under higher hBN dosage (1.8 mg F⁻ released g-catalyst⁻¹ hour⁻¹).⁴ LCMS analysis showed that shorter-chain PFAS daughter products (C3-C7) accumulated to a lower extent in the Fe-hBN system (FIGS. 3-4), which is consistent with the observed enhanced defluorination. In addition to enhancing PFOA electrostatic attraction to the photocatalyst, Fe-doping improved catalytic defluorination performance by enhancing electron-hole separation through ligand-to-metal charge transfer, which promotes C—C bond stretching and subsequent carboxyl radical formation. Iron-adsorbed PFOA reactions are more favorable to further defluorinate short-chain perfluoro carboxylic acid (PFCA) byproducts that are less hydrophobic, which was corroborated with DFT analysis discussed below.

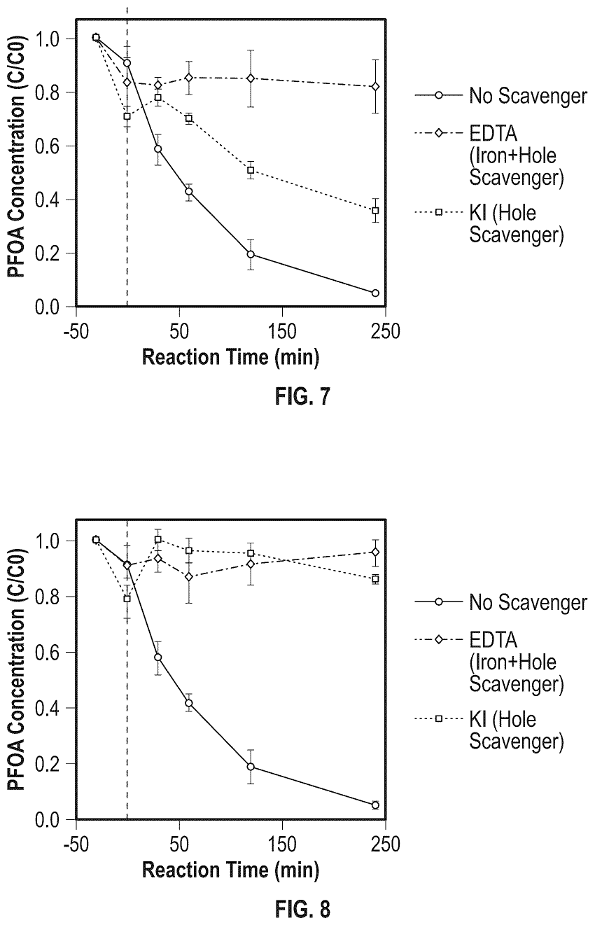

FIGS. 7-8 show that election hole scavenger studies reveal the important of Fe (III). Further FIGS. 7-8 corroborate the critical role of the photogenerated hole in PFOA degradation. These studies employed ethylenediaminetetraacetic acid (EDTA), an iron chelator and electron hole scavenger, and potassium iodide (KI), a hole scavenger, to prove the importance of the photogenerated hole and the iron (Fe) for the removal of PFOA using Fe-hBN (FIG. 7) as compared to hBN (FIG. 8).

FIGS. 7-8 illustrate that scavenger test demonstrated the important of both the photo catalytically generated hole and the imbedded Fe(III). PFOA photocatalytic degradation requires irradiation and Fe-hBN or hBN; no degradation was observed in the dark or when irradiated with 254 nm light (64.4 W m⁻²) without Fe-hBN or hBN. Radical scavenger experiments inform the role of photogenerated holes and Fe (III) in photocatalytic degradation experiments. In the absence of scavengers, hBN and Fe-hBN achieved similar PFOA removal rates (FIG. 2). When potassium iodide (KI, hole scavenger) was added, hBN removal was completely inhibited, corroborating that electron holes are the primary oxidant for PFOA degradation (FIG. 8). However, when KI was added to the Fe-hBN system, PFOA removal was only partially inhibited, suggesting that iron participates in PFOA removal (FIG. 7). In fact, Fe-hBN system was completely inhibited by ethylenediaminetetraacetic acid (EDTA, hole scavenger and iron chelator) (FIG. 7). Thus, the imbedded Fe(III) can remove some PFOA independent of the photogenerated holes in hBN, as shown by decreased PFOA concentrations in the Fe-hBN but not hBN system before the onset of irradiation (FIG. 1). This removal likely involved electrostatic adsorption of the anionic carboxylic head of PFOA to cationic Fe (III), as reported elsewhere and as corroborated below by DFT analysis.

Reactive oxygen species such as hydroxyl and superoxide radicals cannot initiate PFOA degradation and were not investigated in these examples. However, such radicals are generated in photocatalytic hBN systems and may facilitate in the degradation and of PFOA degradation byproducts, for example facilitating hydroxylation via the DHEH defluorination pathway.

Further investigations revealed that the solvothermal process inhibited hBN photocatalytic activity, which was restored by Fe-doping. FTIR measurements show the alkylated DES-hBN samples exhibit C—H stretches at ˜2900 cm⁻¹ and a broad peak at ˜3410 cm⁻¹ attributed to O—H/N—H bonds (not shown). Thermogravimetric analysis (TGA) measurements (not shown) show a slight increase in mass loss for DES-hBN compared to others due to alkylation and the covalent grafting of C—H bonds in the BN network, which was corroborated by elemental ratios in the X-ray photoelectron spectroscopy (XPS) survey spectra and high-resolution scans (not shown). The mass gain observed at higher temperatures (˜900° C.) is attributed to formation of B₂O₃ and Iron (II) oxide species. High-density alky grafting on the DES-hBN limits contact with PFOA, impairing the critical interaction with the electron hole, an important step in initiating PFOA degradation. DES-hBN exhibited an impaired degradation capacity (FIG. 2) because of this limitation. Therefore, further PFOA degradation tests with DES-hBN were not conducted. Fe addition by doping restored the photocatalytic activity that had been impaired by the solvothermal process. Photocatalytic treatment with Fe-hBN yielded a PFOA half-life of 0.75 hours (h) with a removal rate of 0.174 mg L⁻¹ min⁻¹ of PFOA, comparable to the hBN system's PFOA half-life of 1.0 h and 0.166 mg L⁻¹ min⁻¹ of PFOA removal rate (FIG. 2).

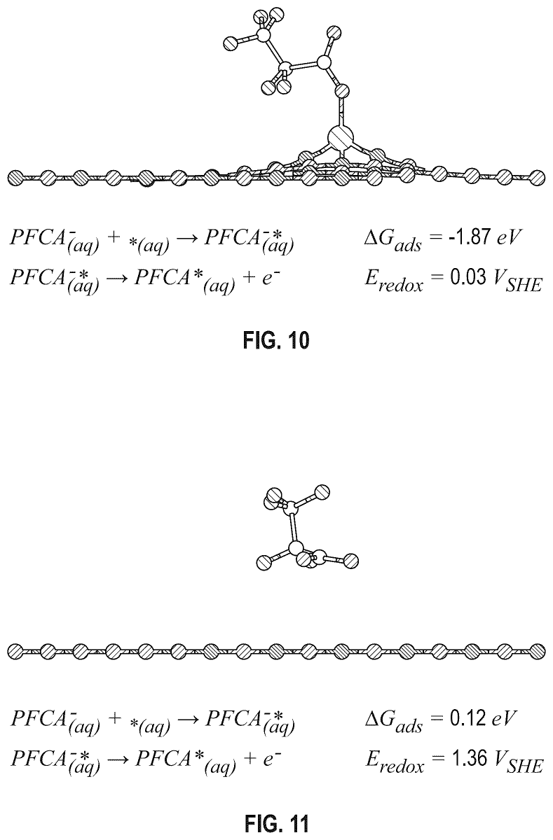

FIGS. 10-13 illustrate results of the density functional theory (DFT) analysis. C3 PFCA was used, which is representative of the oxidation potential of PFO and appropriate for assessing the effect of doping Fe(III) on charge transfer, for computational efficiency.

FIG. 10 shows CF3CF2COO— (−1 e) adsorption on neutral 6×6 Fe(III) doped hBN surface. The net charge of the unit cell after PFAC− adsorption is −1 e. The adsorption free energy (ΔG_{ads}) and the subsequent surface oxidation reaction potential (E_{redox}) is noted in the figure. FIG. 11 shows comparative CF3CF2COO— (−1 e) adsorption on neutral pristine 6×6 hBN surface. The net charge of the unit cell after PFCA− adsorption is −1 e.

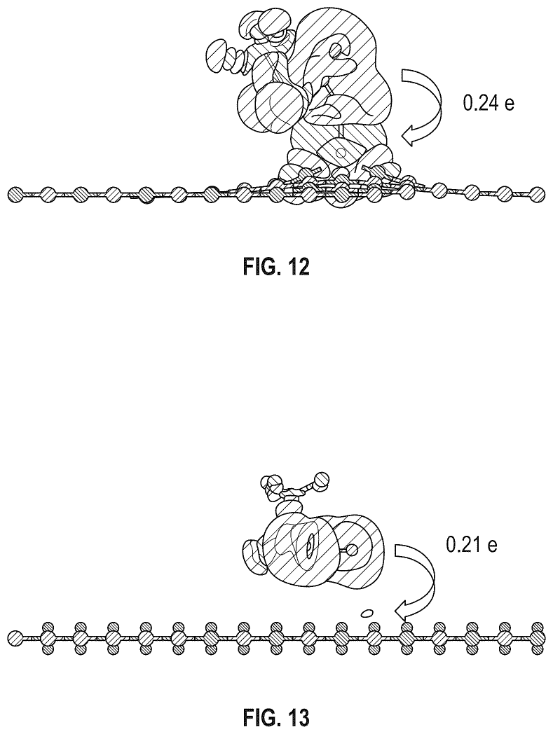

FIG. 12 shows Electron density transfer between CF₃CF₂COO⁻ (−1 e) and Fe(III) doped hBN surface with one photogenerated hole present on the 6×6 surface model (+1 e). The net charge of the simulation cell after PFAC⁻ adsorption is 0 e. The isosurface crosshatched diagonally upwards to the right represents electron density depletion and the isosurface crosshatch diagonally upwards to the left represents electron density accumulation. The isosurface level of charge accumulation and depletion is 0.002 e Å⁻³. The arrow shows the charge transfer from PFCA⁻ to hBN surface and the computed amount of the electron transferred using Bader charge analysis is noted. FIG. 13 shows comparative electron density transfer between CF3CF2COO— (−1 e) and pristine hBN surface with one photogenerated hole present on the 6×6 surface model (+1 e). The net charge of the simulation cell after PFCA− adsorption is 0 e.

The present inventors found that the DFT analysis allowed inference of DHEH mechanisms involving the electron hole and Fe(III). DFT was utilized to elucidate how Fe(III) doping influences the oxidative degradation mechanism of PFCA for assessing the effect of iron doping on charge transfer. As noted above, C3 PFCA was used, which is representative of the oxidation potential of PFOA and appropriate for assessing the effect of doping Fe(III) on charge transfer, for computational efficiency. The investigation focused first on adsorption of the PFCA⁻ anion onto the hBN surface, which constitutes the initial step of the PFCA degradation pathway. A strong adsorption typically facilitates the subsequent reactions on the catalyst surface. When the PFCA⁻ anion (CF3CF2COO⁻) is present on the pristine hBN surface, their interaction is dictated by van der Waals forces with an adsorption free energy of 0.12 eV (FIG. 11). The weak adsorption of this PFCA and pristine hBN inhibits initiation of the cyclic degradation mechanism, explaining why hBN does not effectively degrade shorter-chain PFCAs (FIG. 12). In contrast, upon doping with Fe atoms, the PFCA⁻ anion adsorbs onto the Fe(III) site strongly via a Fe—O chemical bond with a much more favorable adsorption free energy of −1.87 eV (FIG. 10). Furthermore, we assessed the feasibility of PFCA⁻ oxidation on each site by computing the redox potential of the adsorbed PFCA⁻ anion on the hBN and Fe-hBN sites, using Eqns. 3-6. The adsorbed PFCA⁻ oxidation is more favorable on Fe-hBN (0.03 V_{SHE}) than pristine hBN (1.36 V_{SHE}), suggesting that the chemisorbed PFCA⁻ anion on Fe site is subject to easier oxidation (FIGS. 10-11). This result is intuitive, as the Fe—O chemical bond stabilizes the carboxyl radical formed by the oxidation step. Therefore, Fe doping enhances the adsorption and the subsequent photo-oxidative degradation of PFCA chains, resulting in less short-chain PFCA accumulation and a higher defluorination extent (FIGS. 12-13). The charge transfer between the PFCA⁻ anion and the hBN surface models was also analyzed using Bader charge analysis. Under the same photo-oxidative conditions (i.e., one photogenerated hole present on a 6×6 surface model, this corresponds to a surface charge density of 8.14 μC cm⁻² before adsorption), the amount of charge transferred from the PFCA⁻ anion to the Fe-doped hBN surface (0.24 e⁻) is slightly larger than that on the basal plane of pristine hBN (0.21 e⁻). Moreover, there are significant differences in the shape and position of the isosurfaces in FIGS. 12-13, which correspond to the distinct orbitals at the valence band edge where the photo-generated holes are localized on pristine and Fe-hBN. As illustrated by the yellow isosurface in our analysis, on pristine hBN, holes are delocalized on the N atoms on the surface (FIG. 13). Conversely, in the Fe-hBN system, the predominant charge transfer takes place on the Fe(III) site, indicating a localized distribution of holes on the doped Fe (FIG. 12). Therefore, in addition to enabling stronger adsorption through chemical bonding as well as a more feasible charge transfer, Fe doping also promotes hole localization, potentially improving charge carrier separation and mitigating the recombination of photo-excited electrons and photo-generated holes.

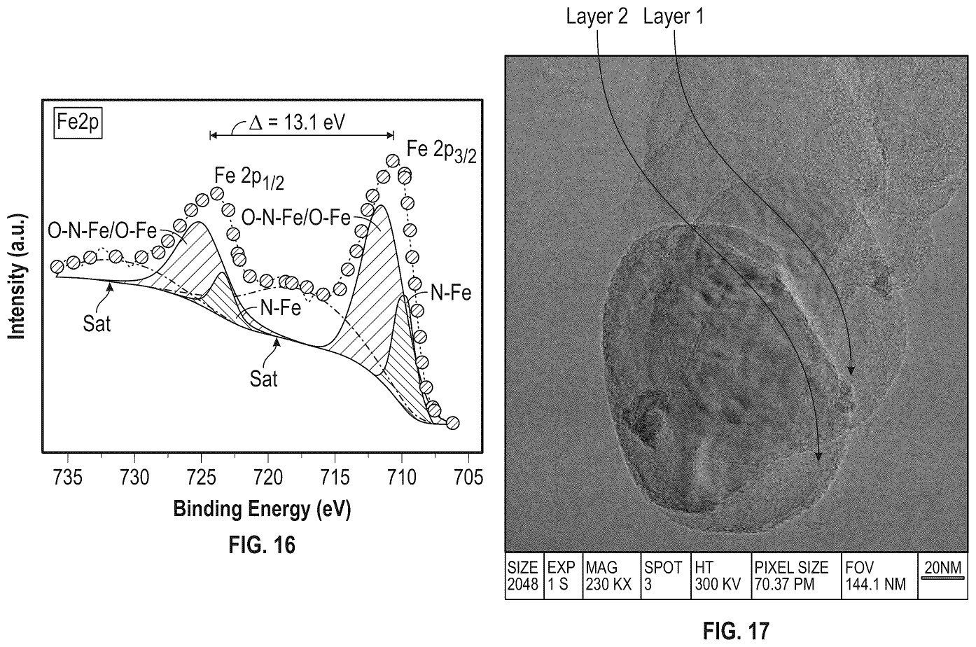

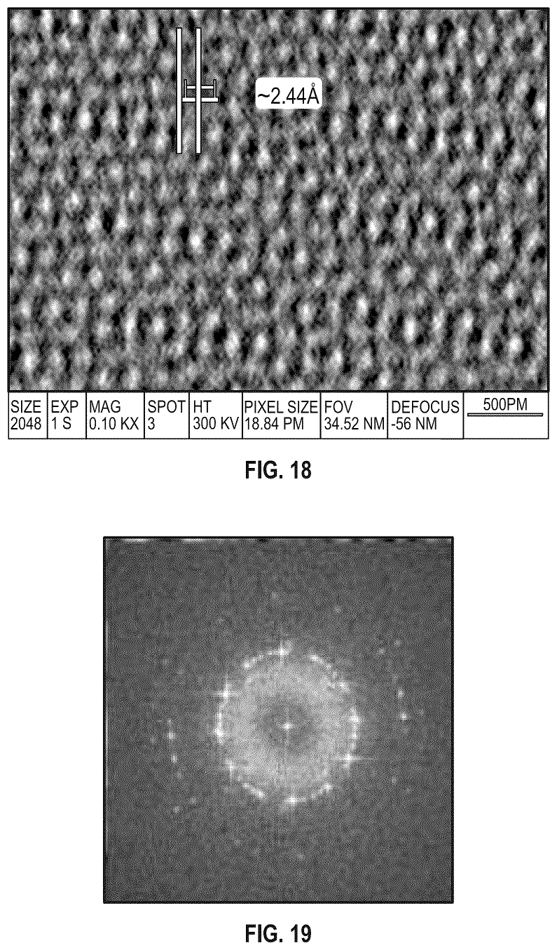

FIGS. 14-19 illustrate characterization of the nanocomposite. FIGS. 14-16 show high-resolution elemental scan and TEM analysis of Fe-hBN. Deconvoluted XPS curve fitting through B1s (FIG. 14), N1s (FIG. 15), and Fe2p (FIG. 16) deconvoluted XPS curve-fitting. These data confirm that the doping process created Fe—N, Fe—O and/or O—N—Fe bonds that indicate a stable heterogeneous material. FIG. 17 shows a TEM image of Fe-hBN displaying stacked hBN sheets without Fe atom clustering. FIG. 18 illustrates HRTEM analysis showing the in-plane distance between two identical atoms of a≈0.245 nm. FIG. 19 shows their corresponding Fast Fourier Transforms (FFT) pattern.

The present inventors found that doping of hBN creates lattice distortion via alkylation followed by addition of Fe(III), resulting in useful defect states. The facile functionalization methodology adopted here involves alkylating and creating a defect-rich hBN in-situ under solvothermal conditions. Heating DES at 180° C. forms several alkyl amine-based products that act as excellent precursors to functionalize and create a defect-rich hBN (DES-hBN). Several approaches including the Billups-Birch reaction have indicated alkylation of hBN, particularly at the boron site due to higher electron density concentrating there, attributed to the vacant p-orbital of boron and the anionic component of nitrogen attacking the lone pairs of nitrogen. Moreover, DES-hBN can be further reacted with Iron (II) chloride to displace these alkyl groups by anchoring Fe atoms to the matrix, thus forming defect-rich Fe-hBN nanocomposite material (not shown).

X-ray diffraction (XRD) spectra (not shown) demonstrated the crystalline nature of all three samples—hBN, DES-hBN, and Fe-hBN matching with JCPDF file 00-045-0894. The consistent increase in the full width half maximum values of hBN, DES-hBN, and Fe-hBN at 0.5226, 0.6883, and 0.7081 respectively is indicative of higher order of defects coming from the lattice distortion in these samples. Moreover, the crystallite size of Fe-hBN decreased (12.06 nm) compared to pure hBN (16.33 nm). This decrease was attributed to a short-range order and the formation of many defects in the system from the solvent-treated methodology adopted in these examples. The (002) plane shown by a peak at ˜26.74° shifted to the right but was not attributed to the slight lattice contraction because lattice compressed hBN, although rare, should relax back to its original state. Moreover, lattice contracting hBN requires a very high pressure and temperature, not achievable under the current solvothermal conditions. Fourier-transform infrared spectroscopy (FTIR) measurements show characteristic peaks ascribed to B—N stretch and B—N bend for pure hBN at ˜1355 cm⁻¹ and ˜763 cm⁻¹ (not shown). The DES-hBN and Fe-hBN samples show a higher shift to 1359 cm⁻¹ and 765 cm⁻¹, respectively, attributed to the lattice distortion. A peak at ˜960 cm⁻¹ found in all samples, including the control precursor hBN, is characteristic of B—N—O stretch. This is attributed to moisture/surface OH, as corroborated by XPS scans obtained showing N—O and B—O bond formations in all samples.

The present inventors found that covalent attachment of Fe to defect-rich hBN reduced bandgap with ‘p’-type doping. The high-resolution elemental scan of Fe-hBN (FIGS. 14-16) displays peak positions attributed to B—N and N—B bonds at ˜190.63 eV and 398.17 eV, found in B1s and N1s respectively. The Fe2p peaks were resolved simultaneously using a spin-orbital splitting of 13.1 eV and a 2:1 area ratio maintained between the 2p^{3/2} and 2p^{1/2} deconvoluted peak positions. Characteristic satellite peaks were found at ˜718.25 eV and ˜731.26 eV, with a central peak at ˜709.15 eV and ˜711.72 eV ascribed to Fe—N and Fe—O/O—N—Fe (iron-oxynitride) species.⁹⁹⁻¹⁰⁰ Note that while solvothermal reactions can readily form Fe—O (iron oxide species), we do not rule out the formation of O—N—Fe (iron oxynitride species) due to their similar binding energies. Fe—N covalent bonds in the Nis spectra at ˜397 eV were identified, signifying the formation of a stable heterogenous material. Fe-hBN samples displayed decreased bandgap calculated from diffuse reflectance spectroscopy (DRS) measurements (Tauc plots) and increased, broader absorption characteristics (UVC to UVA) than hBN samples (not shown). The valence band maximum (VBM) obtained from the valence band spectroscopy (not shown) reaffirms that the inclusion of Fe (III) decreased the VBM-Fermi gap achieving ‘p’-type doping, in the core orbitals of the BN system, causing the system to have more intermediary defect states below the fermi level.

The present inventors found that HAADF-STEM imaging displays uniform Fe distribution on hBN sheets. The low-magnification TEM image shows the presence of several stacked hBN sheets with no prospect of metal clustering, which can be attributed to the low percentage of iron in the material (FIG. 17) This also suggests that adding a low percentage of iron might have resulted in uniform iron distribution rather than metal clustering. A closer look through High resolution TEM (HRTEM) of Fe-hBN (FIG. 18) displays a decrease in the in-plane value a=˜0.245 nm compared to a=˜0.253 nm for pristine hBN (not shown). The present inventors attribute this to the in-plane contraction arising from the increase in defects within the BN system that creates lattice distortion and reduced crystallinity after doping. The Fast Fourier Transforms (FFT) pattern shown in FIG. 19 displays the polycrystalline nature of the hBN. Energy dispersive spectrometry (EDS) mapping to understand the distribution of elements in the sample, which confirmed the presence of B, N, and Fe (not shown). HAADF-STEM region mapping also confirmed the uniform distribution of Fe atoms. Further, a STEM-EDS spectrum (not shown) and HAADF profile mapping of Fe-hBN (not shown) confirmed the presence of B, N, and Fe.

The present examples have successfully demonstrated the feasibility of producing a Fe-hBN nanocomposite in scalable quantities through simple chemistries and easily accessible resources. Moreover, these examples produced a defluorination rate of ˜50% of F⁻ species, the highest defluorination rate demonstrated amongst all hBN and hBN nanocomposites.

Further, this methodology is not limited to merely iron doping in hBN. However, it is valid for a more comprehensive range of transition metals such as copper-hBN and other metal nanocomposite development for applications ranging from lubrication to electronic modulation and device applications.

The versatility of hBN and its modification through the functionalization and doping using a transition metal like iron has several implications in diverse areas. In particular, Fe-hBN provides a new perspective on increased degradation and defluorination rate of PFOA using a photooxidation mechanism, as observed. Other applications include the following. The photocatalytic applications of Fe-hBN are not limited to PFOA but also include complex organic dye removal, tannery effluents, and other contaminated water systems. hBN-Fe nanocomposites are also relevant for optoelectronic and spintronic applications. Further, hBN metal composites can also lead to the development of sintered materials for space applications. hBN nanocomposites are also relevant for electrocatalysis like HER, OER, and bifunctional catalysis due to modified bandgap changes to hBN.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A nanocomposite, comprising:
boron nitride doped with a metal, wherein the boron nitride doped with a metal is catalytically active for degrading a perfluoroalkyl substance.

2. The nanocomposite of claim 1, wherein the boron nitride comprises hexagonal boron nitride.

3. The nanocomposite of claim 1, wherein the metal comprises a transition metal.

4. The nanocomposite of claim 3, wherein the transition metal comprises iron.

5. The nanocomposite of claim 1, wherein the perfluoroalkyl substance comprises perfluorooctanoic acid.

6. A method of making a nanocomposite, comprising:
forming a mixture by adding a salt comprising a cation of a metal to a powder comprising boron nitride;
forming a dispersion by adding the mixture to a eutectic solvent; and
reacting the metal with the boron nitride to form a product comprising the nanocomposite by heating the dispersion.

7. The method of claim 6, wherein the metal comprises a transition metal.

8. The method of claim 6, wherein the wherein the boron nitride comprises hexagonal boron nitride.

9. The method of claim 6, wherein the nanocomposite is catalytically active for degrading a perfluoroalkyl substance.

10. The method of claim 9, wherein the perfluoroalkyl substance comprises perfluorooctanoic acid.

11. The method of claim 6, wherein the eutectic solvent is a deep eutectic solvent.

12. The method of claim 6, wherein the eutectic solvent comprises a combination of ethylene glycol and choline chloride.

13. The method of claim 6, further comprising adding a secondary solvent to the eutectic solvent.

14. The method of claim 13, wherein the secondary solvent comprises dimethylformamide.

15. The method of claim 6, further comprising:
forming a phase-separated mixture by washing the product with a mixture of a polar solvent and nonpolar solvent; and
removing unreacted and organic byproducts from the phase-separated mixture.

16. A method of treating a perfluoroalkyl substance, comprising:
contacting the perfluoroalkyl substance with a nanocomposite comprising boron nitride doped with a metal; and
degrading the perfluoroalkyl substance with the nanocomposite.

17. The method of claim 16, wherein the perfluoroalkyl substance comprises perfluorooctanoic acid.

18. The method of claim 16, wherein the wherein the boron nitride comprises hexagonal boron nitride.

19. The method of claim 16, wherein the metal comprises a transition metal.

20. The method of claim 19, wherein the transition metal comprises iron.
